(19) United States
(12) Patent Application Publication
(10) Pub. No.: US 2015/0012330 A1
(43) Pub. Date: Jan. 8, 2015

(54) WORK MANAGEMENT METHOD

(71) Applicant: FUJITSU LIMITED, Kawasaki-shi (JP)

(72) Inventors: Yoshiaki SUGIURA, Numazu (JP); Kazuhiko Noba, Yokohama (JP)

(21) Appl. No.: 14/317,324

(22) Filed: Jun. 27, 2014

(30) Foreign Application Priority Data
Jul. 5, 2013 (JP) 2013-141628

(51) Int. Cl. G06Q 10/06

(52) U.S. Cl. CPC G06Q 10/06316
USPC 705/7.26

(57) ABSTRACT

A work management method executed by an information processing apparatus, includes setting an execution attribute for each of a plurality of tasks included in a work process, the execution attribute specifying an execution order relationship with respect to the other tasks in the plurality of tasks; and generating a Gantt chart using the plurality of tasks having the execution attributes set, wherein a child task of tasks having a parent-child relationship among the plurality of tasks included in the generated Gantt chart has execution content corresponding to the execution attribute set for a parent task of the tasks having the parent-child relationship.

### CROSS-REFERENCE TO RELATED APPLICATIONS

This application is based upon and claims the benefit of priority of the prior Japanese Priority Application No. 2013-141628 filed on Jul. 5, 2013, the entire contents of which are hereby incorporated by reference.

### FIELD

The disclosures herein generally relate to a work management method.

### BACKGROUND

The Gantt chart is known as one of the methods of managing the schedule and progress state of work in fields including project management and production management. By displaying individual tasks with bars that correspond to work processes, a Gantt chart can describe work states and the like on a time axis, and parent-child relationships between tasks using indents (steps); hence it is widely used such as showing a list of multiple tasks and the like. Also, there are methods of adding items to a Gantt chart that cannot be directly described in a usual Gantt chart, by attaching attributes to respective tasks represented in the Gantt chart (see, for example, Patent Documents 1-4).

### RELATED-ART DOCUMENTS

### Patent Documents

[Patent Document 1] Japanese Laid-open Patent Publication No. 2010-55191
[Patent Document 2] Japanese Laid-open Patent Publication No. 8-287140
[Patent Document 3] Japanese Laid-open Patent Publication No. 11-305826
[Patent Document 4] Japanese Laid-open Patent Publication No. 10-118896

Although it is possible to add multiple items of information to a Gantt chart by attaching attributes to respective tasks as described above, relationships between tasks cannot be clearly described. For example, an indent representation used in such a Gantt chart as above is not sufficient for describing a process or the like that includes various determination controls such as conditional branching, repeat controls, and the like.

Therefore, content that can be described with a process definition flow (process chart) or the like, for example, an execution order of multiple tasks cannot be represented with a Gantt chart, and appropriate work management that requires such an execution order and the like cannot be realized only with the Gantt chart.

### SUMMARY

According to at least one embodiment of the present invention, a work management method executed by an information processing apparatus includes setting an execution attribute for each of a plurality of tasks included in a work process, the execution attribute specifying an execution order relationship with respect to the other tasks in the plurality of tasks; and generating a Gantt chart using the plurality of tasks having the execution attributes set, wherein a child task of tasks having a parent-child relationship among the plurality of tasks included in the generated Gantt chart has execution content corresponding to the execution attribute set for a parent task of the tasks having the parent-child relationship.

The object and advantages of the embodiment will be realized and attained by means of the elements and combinations particularly pointed out in the claims. It is to be understood that both the foregoing general description and the following detailed description are exemplary and explanatory and are not restrictive of the invention as claimed.

### BRIEF DESCRIPTION OF DRAWINGS

FIG. 1 is a schematic view illustrating an example of a functional configuration of a work management apparatus;

FIG. 2 is a schematic view illustrating an example of a hardware configuration of a work management apparatus;

FIG. 3 is a flowchart illustrating an example of a process of a work management apparatus;

FIGS. 4A-4B are first schematics views illustrating a correspondence between a Gantt chart and a process definition flow with respect to a conditional branch;

FIGS. 5A-5B are second schematics views illustrating a correspondence between a Gantt chart and a process definition flow with respect to a conditional branch;

FIGS. 6A-6B are third schematic views illustrating a correspondence between a Gantt chart and a process definition flow with respect to a conditional branch;

FIGS. 7A-7C are schematic views illustrating an example of task hierarchy setting information;

FIG. 8A-8B are schematic views illustrating a correspondence between a Gantt chart and a process definition flow with respect to “while do”;

FIG. 9A-9B are schematic views illustrating a correspondence between a Gantt chart and a process definition flow with respect to “do while”;

FIGS. 10A-10B are schematic views illustrating an example of a management data structure in a process definition;

FIG. 11 is a flowchart illustrating an example of a conditional node determination process in a Gantt chart editor;

FIGS. 12A-12C are schematic views illustrating an example where marks are attached to tasks reachable from a conditional node;

FIGS. 13A-13D are first schematic views illustrating a determination example of conditional nodes in a case where multiple conditional nodes coexist;

FIGS. 14A-14D are second schematic views illustrating a determination example of conditional nodes in a case where multiple conditional nodes coexist;

FIGS. 15A-15D are third schematic views illustrating a determination example of conditional nodes in a case where multiple conditional nodes coexist; and

FIG. 16 is a schematic view illustrating an example of a Gantt chart.

### DESCRIPTION OF EMBODIMENTS

In the following, embodiments of the present invention will be described with reference to the drawings.

<Example of Functional Configuration of Work Management Apparatus>

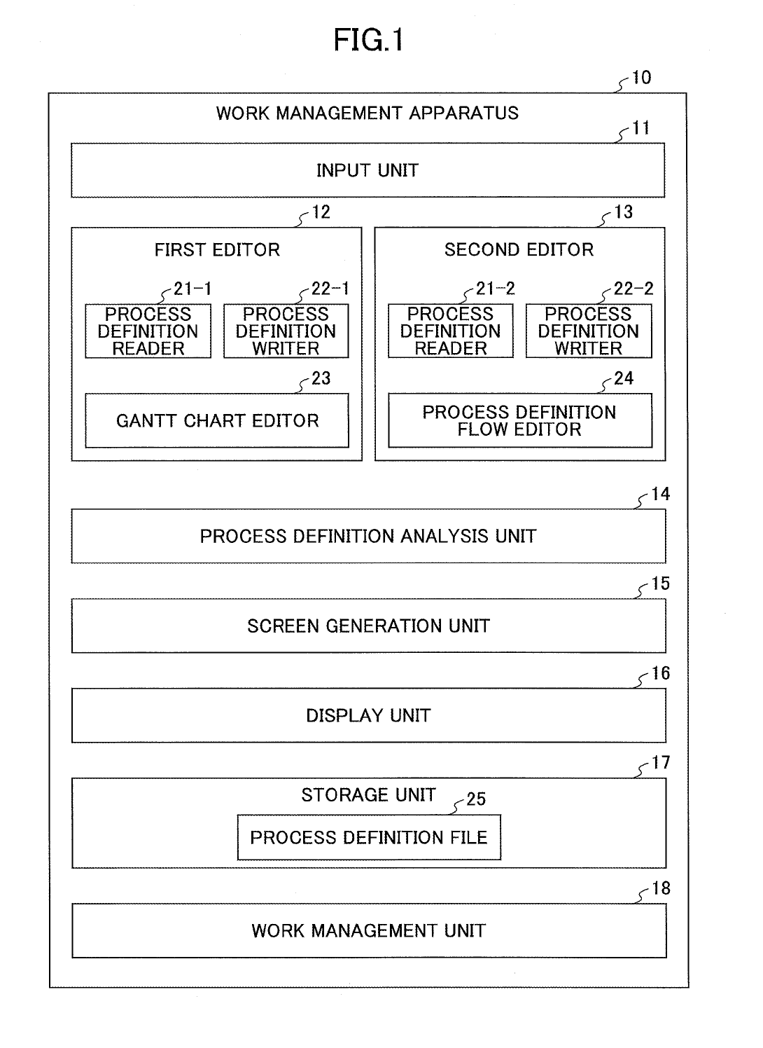

FIG. 1 is a schematic view illustrating an example of a functional configuration of a work management apparatus 10. The work management apparatus 10 exemplified in FIG. 1 is an information processing apparatus, for example, a personal computer (PC). Alternatively, the work management apparatus 10 may be a server or the like that can be accessed from, for example, multiple PCs via a communication network such as the Internet or a local area network (LAN).

The work management apparatus 10 includes an input unit 11, a first editor 12, a second editor 13, a process definition analysis unit 14, a screen generation unit 15, a display unit 16, a storage unit 17, and a work management unit 18. The first editor includes a process definition reader 21-1, a process definition writer 22-1, and a Gantt chart editor 23. The second editor 13 includes a process definition reader 21-2, a process definition writer 22-2, and a process definition flow editor. Also, the storage unit 17 includes a process definition file 25.

The input unit 11 receives start and end commands for various directions and input of various settings and the like about a work management process from a user of the work management apparatus 10. The input unit 11 includes, for example, a keyboard and a mouse. Also, if the work management apparatus 10 is configured to be accessed from an external device via a communication network as described above, the input unit 11 obtains input information from the external terminal.

The first editor 12 assigns tasks to processes in a project or the like that is received at the input unit 11 to have work management applied, and sets an execution attribute for each of the multiple assigned tasks that specifies an execution order relationship with the other tasks. The first editor 12 also assigns a person in charge (worker) for each of the tasks, sets a schedule or the like, and generates a Gantt chart based on the various input information. The task here is not limited to work executed by a worker, but may be, for example, an automatic execution of a predetermined application, transmission of electronic mail, communication with an existing Web service, or the like.

Also, the first editor 12 obtains a process definition stored in the process definition file 25 to generate a Gantt chart that corresponds to the obtained process definition. Specifically, the process definition reader 21-1 of the first editor 12 reads the process definition that corresponds to a project to be processed stored in the process definition file 25. The process definition is, for example, management data that is set for each node (task) represented by a process definition flow (process chart) or the like, and for each branch (arrow) that makes a connection between nodes, but it is not limited to these.

The Gantt chart editor 23 generates a Gantt chart that corresponds to the information input at the input unit 11 by a user and the process definition read by the process definition reader 21-1.

Note that a conditional branch cannot be defined in a conventional Gantt chart because execution steps (workflow) of multiple tasks are not sequential. Also, repeat control cannot be defined because a conventional Gantt chart does not deal with a concept of “return”. Thereupon, the Gantt chart editor 23 makes it possible to describe a process by using at least one of the following elements that are directly displayed: a label of a task constituting a Gantt chart that corresponds to a work process; a description position (indent); a column description; and a bar display or the like. The process is, for example, an execution order of a conditional branch or repeat control, which is described by specifying an execution attribute using the elements described above. Also, the label is, for example, at least one piece of information among the color, shape, style or the like of characters of a task name described in a Gantt chart, but it is not limited to these.

The Gantt chart editor 23 sets an execution attribute or a parent-child relationship for each of one or more tasks included in a work process that corresponds to a project or the like to be processed. Thus, the execution attribute and the parent-child relationship can be represented using the Gantt chart editor 23. Therefore, it is possible to represent in the Gantt chart that, for example, a child task, which has a parent-child relationship with a parent task having an execution attribute set, is a task that has execution content corresponding to the execution attribute (for example, conditional branch (if), repeat control (do while, while do)) of the parent task. In this way, representation capability of a Gantt chart can be improved according to the present embodiment.

A screen is generated by the screen generation unit 15 for a Gantt chart edited with the Gantt chart editor 23, which is then displayed on the display unit 16. The user refers to the Gantt chart displayed on the display unit 16, and inputs a change command at the input unit 11 if there is a part to be changed. The Gantt chart editor 23 re-edits the Gantt chart in response to the input change command, and displays it on the display unit 16.

Also, the process definition writer 22-1 of the first editor 12 writes a process definition that corresponds to the Gantt chart edited with the Gantt chart editor 23 in the process definition file 25 when receiving a command from the Gantt chart editor 23.

The second editor 13 obtains a process definition stored in the process definition file 25, and generates a process definition flow that corresponds to the obtained process definition. Specifically, the process definition reader 21-2 of the second editor 13 reads the process definition that corresponds to a project to be processed stored in the process definition file 25. The process definition at this moment may be a process definition that corresponds to a Gantt chart edited with the first editor 12, or a process definition generated with the second editor 13 in the past.

The process definition flow editor 24 generates a process definition flow, which is execution steps or a workflow that corresponds to the process definition read from the process definition reader 21-2. Note that the process definition flow editor 24 may generate a process definition flow based on information input at the input unit 11 by the user or the like as described above.

A screen is generated by the screen generation unit 15 for the process definition flow edited with the process definition flow editor 24, which is then displayed on the display unit 16. The user refers to the process definition flow displayed on the display unit 16, and inputs a change command at the input unit 11 if there is a part to be changed. The process definition flow editor 24 re-edits the process definition flow in response to the input change command, and displays it on the display unit 16.

Also, the process definition writer 22-2 of the second editor 13 writes a process definition that corresponds to the process definition flow edited with the process definition flow editor 24 in the process definition file 25 when receiving a command from the process definition flow editor 24.

The process definition analysis unit 14 verifies whether a workflow in the Gantt chart edited with the Gantt chart editor 23 can be configured as a process definition flow, and adds information required for operations in a target operation environment or the like if necessary. The process definition analysis unit 14 also analyzes whether it is feasible to realize the process definition edited with the Gantt chart editor 23 or the process definition flow editor 24, in various conditions of the operation environment set beforehand. The analysis result can be displayed on the display unit 16.

The screen generation unit 15 generates a screen to be displayed for a Gantt chart edited (generated and/or changed, for example) with the Gantt chart editor 23 or a process definition flow edited with the process definition flow editor 24. The screen generation unit 15 also generates a screen to be displayed, for example, for a work progress state or the like in the work management unit 18. The screen generation unit 15 also generates various screens in the present embodiment such as an input screen for settings required to execute a work management process, an error screen, and the like.

The display unit 16 displays a Gantt chart, a process definition flow, various information in the process definition file 25 or the like generated by the screen generation unit 15. The display unit 16 is, for example, a display, a monitor or the like.

The storage unit 17 stores various information required in the present embodiment. For example, the storage unit 17 stores the process definition file 25, a Gantt chart edited with the first editor 12, a process definition flow edited with the second editor 13, various setting information for executing the present embodiment, an execution result of work management, and the like. Also, the storage unit 17 can read the various stored information at a predetermined timing if necessary and can write an execution result or the like of a work management process.

The process definition file 25 in the storage unit 17 is an example of a storage unit, for example, and stores determination control information and a management data structure or the like for each of task nodes and conditional nodes. The process definition file 25 is read by the first editor 12 or the second editor 13 to read a process definition stored beforehand, or written with an updated process definition, with which data in the process definition file 25 is updated in accordance with written content.

The work management unit 18 executes work management on a project or the like to be managed by using a process definition stored in the process definition file 25 in a system where work management is executed. For example, the work management unit 18 manages a start date, an end date, and the like for each task in the project to be managed, has the screen generation unit 15 generate a progress state or the like for each of the tasks that corresponds to a process plan described with a Gantt chart or the like, and has the display unit 16 display the progress state.

If a user determines that change is required for the process plan from the result obtained by the work management unit 18, the user re-edits the Gantt chart and/or the process definition flow with the Gantt chart editor 23 and/or the process definition flow editor 24, respectively. Various information managed by the work management unit 18 is stored in, for example, the storage unit 17.

In the present embodiment, the process definition readers 21-1 and 21-2 in FIG. 1 may be configured as a single element, and the process definition writers 22-1 and 22-2 may also be configured as a single element.

<Hardware Configuration Example of Work Management Apparatus 10>

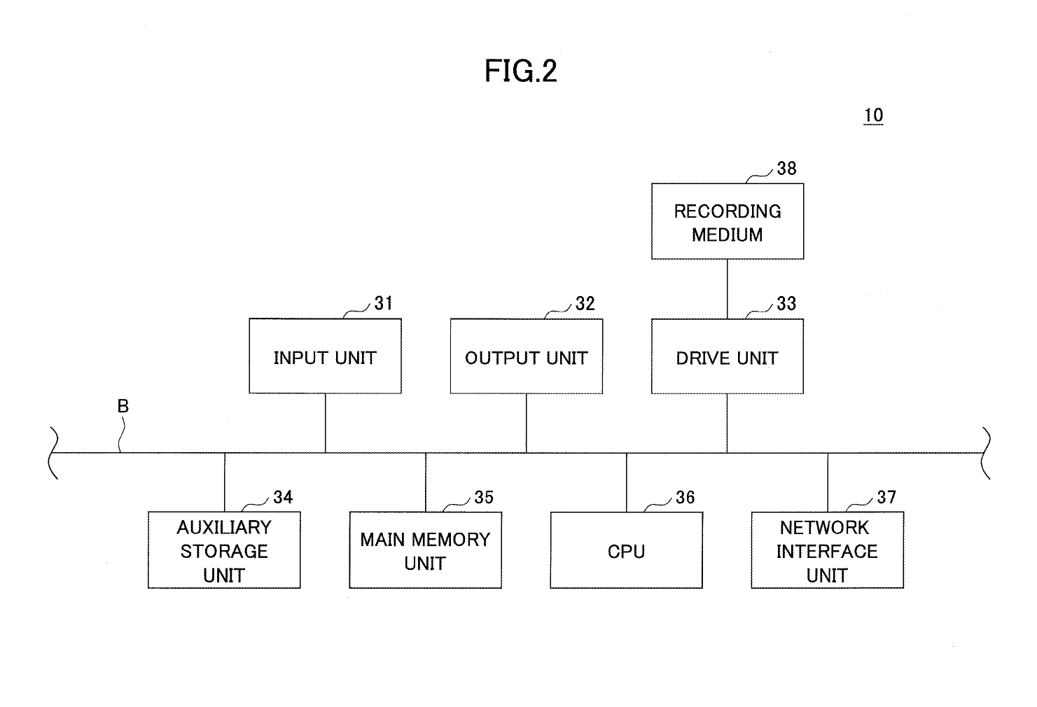

Next, a hardware configuration example of the work management apparatus 10 will be described using the drawings. FIG. 2 is a schematic view illustrating an example of a hardware configuration of the work management apparatus 10.

As illustrated in the example in FIG. 2, the work management apparatus 10 includes an input unit 31, an output unit 32, a drive unit 33, an auxiliary storage unit 34, a main memory unit 35, a CPU 36, and a network interface unit 37, which are mutually connected by a system bus B.

The input unit 31 includes a keyboard, a pointing device such as a mouse or the like, and a voice input device such as a microphone operated by a user to receive as input an execution command of a program from the user, various operation information, information for activating software and the like.

The output unit 32 includes a display for displaying various windows, data and the like to operate the main body of the computer (the work management apparatus 10) to execute processing according to the present embodiment. The output unit 32 displays an execution report and result, etc. of a program by a control program held by the CPU 36.

Note that an execution program installed into the main body of the computer according to the present embodiment is provided, for example, with a portable recording medium 38 or the like. The recording medium 38 that records the program can be set to the drive unit 33. The execution program is installed into the auxiliary storage unit 45 via the drive unit 33 from the recording medium 38 based on a control signal from the CPU 36.

The auxiliary storage unit 34 is, for example, a storage unit such as a hard disk drive, a solid state drive (SSD) or the like. The auxiliary storage unit 34, based on a control signal from the CPU 36, stores the execution program according to the present embodiment, a control program held in the computer, and the like, which can be input or output when necessary. The auxiliary storage unit 34, based on a control signal from the CPU 36, reads or writes required information from or to the stored information.

The main memory unit 35 stores the execution program and the like read from the auxiliary storage unit 34 by the CPU 36. The main memory unit 35 is a read-only memory (ROM), a random access memory (RAM) and the like. The auxiliary storage unit 34 and the main memory unit 35 correspond to, for example, the storage unit 17 that stores the process definition file 25 and the like.

The CPU 36, based on a control program such as an operating system or the like and the execution program stored in the main memory unit 35, executes various calculations, inputs and outputs data to/from the hardware units, and controls the computer as a whole to implement various processing. Various information required for an execution of a program may be obtained from the auxiliary storage unit 34, and an execution result and the like may be stored.

Specifically, the CPU 36, based on an execution command or the like of a program obtained from the input unit 31, for example, runs the program installed in the auxiliary storage unit 34 by loading the program into the main memory unit 35.

For example, by executing the work management program, the CPU 36 executes the processes described above such as editing of a Gantt chart with the first editor 12, editing of a process definition flow with the second editor 13, and an analysis of a process definition by the process definition analysis unit 14, and the like. The CPU 36 also executes the processes including generation of a screen by the screen generation unit 15, displaying of the screen on the display unit 16, work management by the work management unit 18, or the like. Contents to be processed by the CPU 36 are not limited to these. Contents executed by the CPU 36 may be stored in the auxiliary storage unit 45 if necessary.

The network interface unit 37 executes communication with an external device via a communication network such as the Internet, a LAN or the like. The network interface unit 37, based on a control signal from the CPU 36, establishes a connection with a communication network to obtain the execution program, software, setting information, and the like from an external device or the like connected with the communication network. The network interface unit 37 can provide an execution result obtained by executing a program or the execution program itself to the external device.

The recording medium 38 is a portable recording medium, for example, a semiconductor memory such as a flash memory or the like, a CD-ROM, a DVD, etc., but it is not limited to these.

By installing an execution program (for example, the work management program) on the hardware configuration in FIG. 2, the work management process can be implemented by cooperation of the hardware resources and the software according to the present embodiment.

### Work Management Process Example

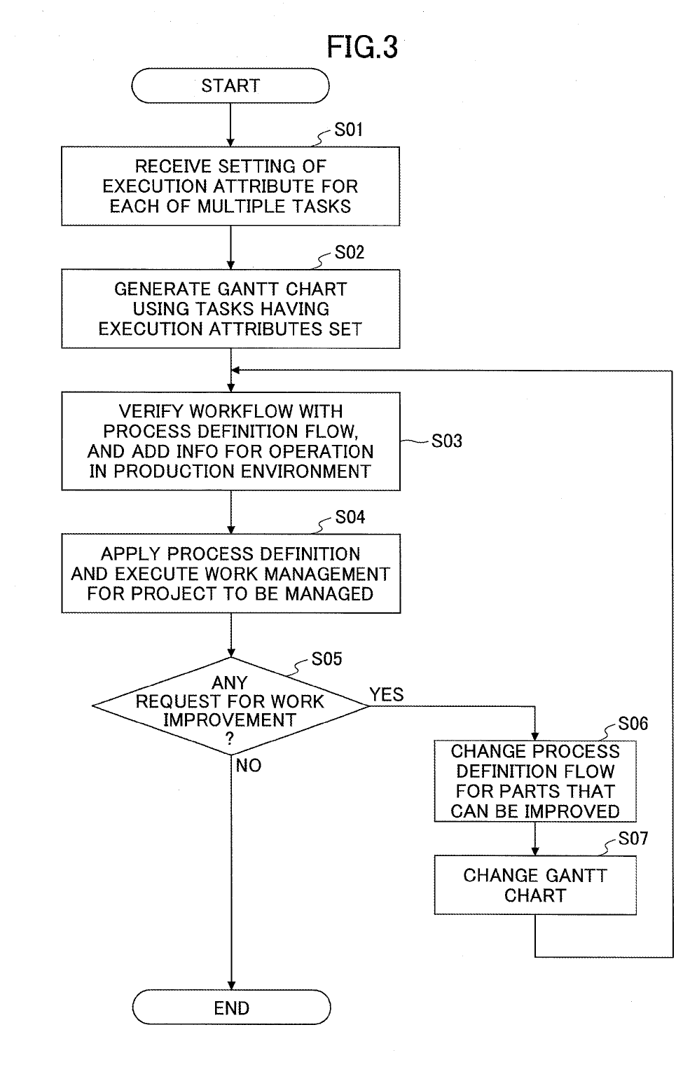

Next, an example of a process on the work management apparatus 10 will be described using a flowchart according to the present embodiment. FIG. 3 is a flowchart illustrating an example of a process on the work management apparatus 10.

In the example in FIG. 3, the first editor of the work management apparatus 10 receives setting of an execution attribute for each of multiple tasks, included in a project to be processed from the input unit 11 or the like (Step S01). Next, using the tasks having their execution attributes set, the first editor 12 generates a Gantt chart that includes a workflow or the like (Step S02). Note that, at Step S02, if the generated Gantt chart includes tasks that have a parent-child relationship among the multiple tasks, the child task is set to have an execution content that corresponds to the execution attribute set in the parent task. The first editor 12 may store the content represented by the Gantt chart in the process definition file 25.

Next, the process definition analysis unit 14 verified a workflow in a process definition flow with the Gantt chart obtained at Step S02, and adds information for operations in a production environment of the work management apparatus 10 (Step S03). For example, using a process definition that corresponds to the Gantt chart obtained at Step S02, the process definition analysis unit 14 verifies whether the workflow can be configured as a process definition flow, and if there are any missing items required to configure the process definition flow, adds information for the missing items. The information to be added may be set beforehand, or may be displayed on the display unit 15 for a user to indicate that there are missing items. Also, if determining that the process definition is wrong, the process definition analysis unit 14 may display an error on the display unit 15 to have a user correct it. An example where the process definition is determined as wrong includes a case where an unnecessary branch or repeat control is set in the execution attribute, but it is not limited to these. Also, the process definition analysis unit 14 may store an analysis result obtained at Step S02 in the storage unit 17, and may also store an updated process definition file 25 based on the analysis.

Next, the work management unit 18 uses the process definition to execute work management of a project or the like to be processed, and starts its operation (Step S04). Here, it is determined whether there is any request for work improvement as a command from a user (administrator) (Step S05), and if there is a request (YES at Step S05), the second editor 13 changes the process definition flow for parts that can be improved (Step S06). Note that the second editor 13 may store the content represented by the Gantt chart in the process definition file 25.

Next, the first editor 12 changes the Gantt chart in accordance with the process definition flow changed at Step S06 (Step S07), and the process goes back to Step S03. Note that the first editor 12 may store the content represented by the changed Gantt chart in the process definition file 25.

If there are no requests for work improvement at Step S05 (NO at Step S05), the work management apparatus 10 ends the process.

Note that editing including generation and change of a Gantt chart at Steps S02 and S07 may be performed by, for example, a person in charge at the site or a person in charge of consulting on the project or the like to be managed. Also, editing of the process definition flow at Step S07 may be performed by, for example, a person in charge in a system construction division or an information system division, but it is not limited to these. As illustrated in FIG. 3, a process description covered by a Gantt chart can be expanded according to the present embodiment; hence the same representation can be substantially realized either of a Gantt chart or a process definition flow. Therefore, a bidirectional conversion can be implemented between a Gantt chart and a process definition flow using the process definition file 25 in the present embodiment. With the above configuration, the work management apparatus 10 can implement appropriate work management using a Gantt chart.

### <Example of Process in Gantt Chart Editor 23>

Next, an example of a process in the Gantt chart editor 23 will be concretely described. Conventionally, a representation by a Gantt chart and representations by process definition flows have a 1-to-n correspondence. For example, a conditional node in a process definition flow has multiple meanings such as a conditional branch, a repeat control node, and the like. Thereupon, when converting a process definition flow to a Gantt chart, the Gantt chart editor 23 identifies whether a conditional node is a conditional branch or a repeat control node, based on nodes before and after the conditional node in the process definition. Also, the meaning of the identified conditional node is added to the description of a Gantt chart.

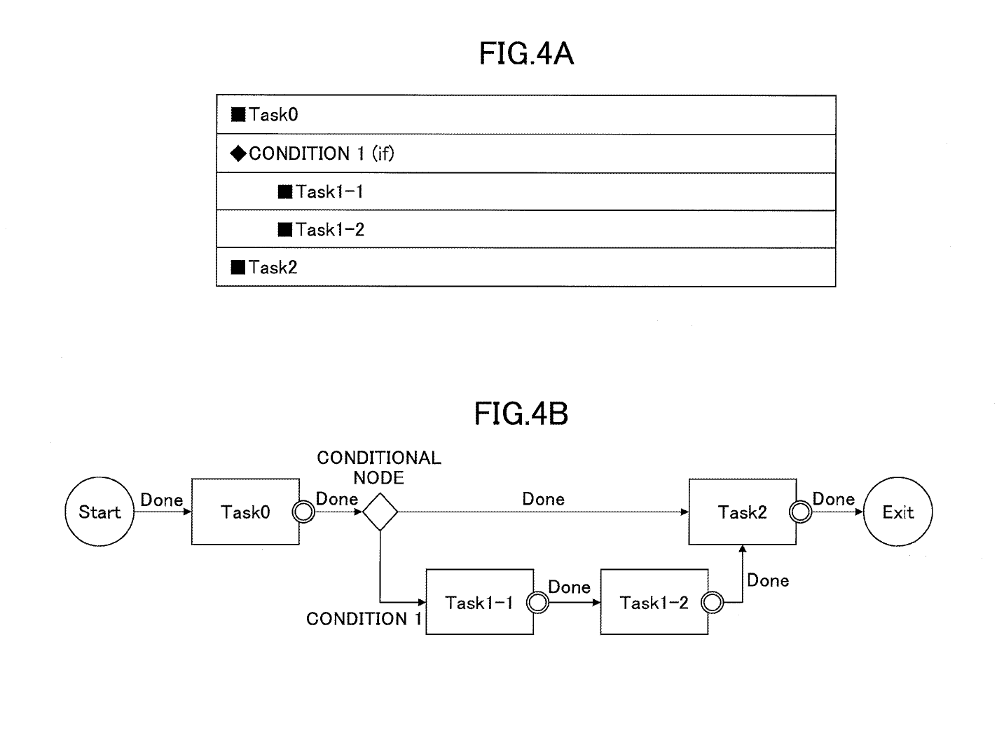

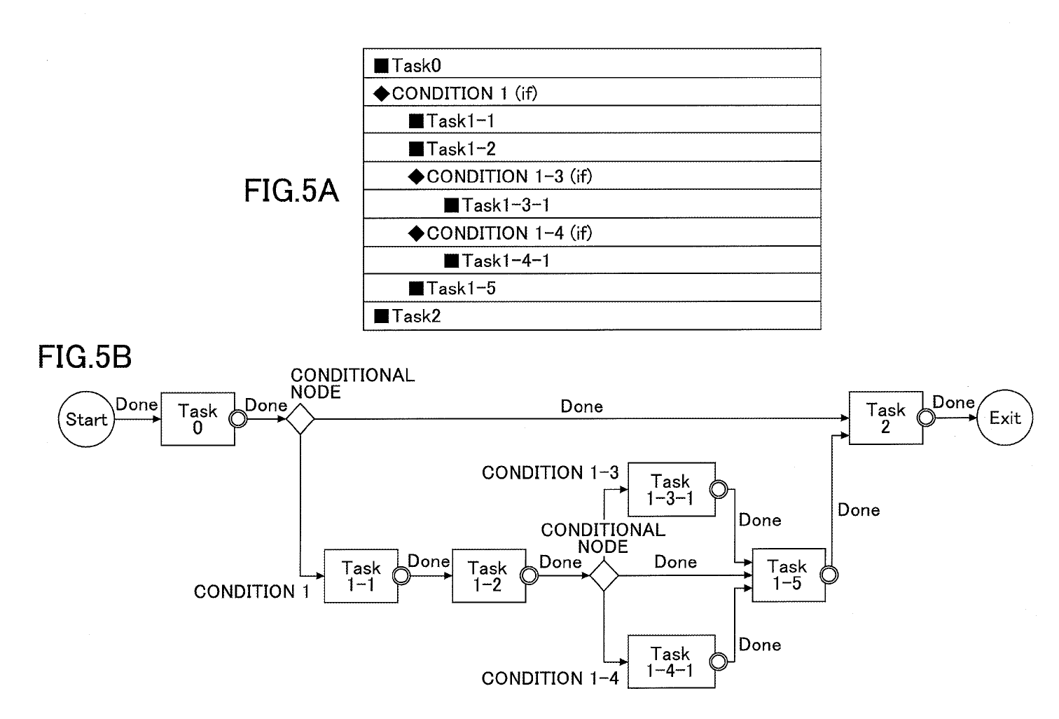

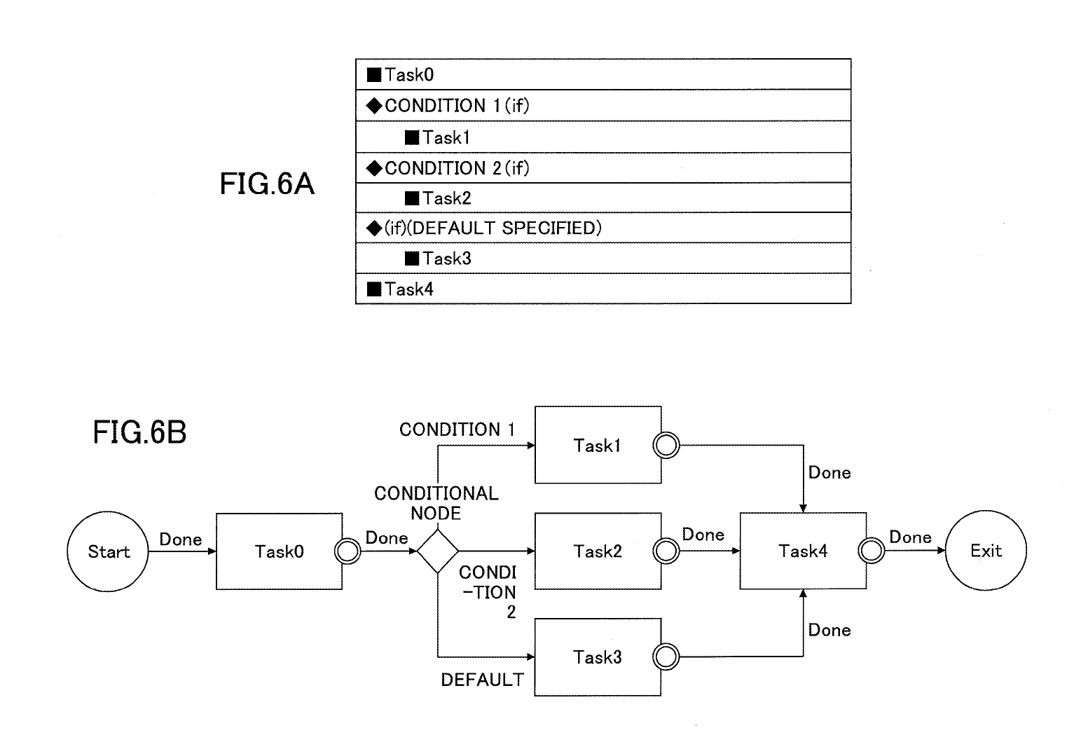

FIGS. 4A-4B, 5A-5B and 6A-6B are first to third schematics views illustrating a correspondence between a Gantt chart and a process definition flow with respect to a conditional branch, respectively. FIG. 4A, FIG. 5A, and FIG. 6A illustrate examples of Gantt charts and FIG. 4B, FIG. 5B, and FIG. 6B illustrate examples of process definition flows that correspond to the Gantt charts, respectively.

Each task constituting a Gantt chart can be set with the same execution attribute as a conditional node according to the present embodiment. The execution attribute of a conditional node can be set with, for example, a type and/or a conditional formula. The type of a conditional node is, for example, “if”, “while do”, or “do while”, but it is not limited to these. Also, based on conditions defined by a conditional formula, a corresponding execution attribute is set to a task, and a child task (including a grandchild task) having a parent-child relationship with the task having the execution attribute set is executed only if the conditional formula is satisfied. Note that parent-child relationships for multiple tasks can be displayed with description positions (indents) or the like in a Gantt chart in the present embodiment, which can be set with the Gantt chart editor 23.

The example in FIG. 4 illustrates a process of tasks having a conditional branch. In the Gantt chart in FIG. 4A, the type of a task is represented by an icon such as “▪” “♦”. Note that the types of icons are not limited to these and other symbols and characters may be used. Also, leaps of description positions (indents) for Tasks 1-1 and 1-2 below CONDITION 1 in the example in FIG. 4A illustrate a hierarchy of the tasks.

In the process illustrated in FIGS. 4A-4B, a first task (Task0) is performed after Start, then a branch to be taken is determined at a conditional node CONDITION 1, and if CONDITION 1 is satisfied, Tasks 1-1 and 1-2 are performed. Note that Tasks 1-1 and 1-2 in FIGS. 4A-4B are child tasks.

If CONDITION 1 is not satisfied in the process in FIGS. 4A-4B, or if Task 1-2 has been performed, Task 2 is performed, and the process ends. Note that “Done” in FIG. 4B means that a task at the source of an arrow has been performed and a task pointed by the arrow is performed next.

The example in FIGS. 5A-5B illustrates a process that includes a nesting of, for example, conditional branches (if statements), namely a process that includes a grandchild task. The example in FIGS. 5A-5B has a child task Task 1-2 further followed by conditional branches (CONDITIONS 1-3 and 1-4), which have branches of grandchild tasks (Tasks 1-3-1 and 1-4-1), respectively.

Note that the first editor 12 can add settings for a conditional node to indicate whether it is a default specification, as a property or the like of the conditional node displayed on a Gantt chart. If it is the default specification, for example, an operation can be defined for a case where defined conditional formulas are not satisfied, which is similar to a default branch construct of a switch statement in a general programming language.

FIGS. 6A-6B illustrate a Gantt chart and a process definition flow in which an if statement that corresponds to the above switch statement is used as a conditional branch. As illustrated in the example in FIGS. 6A-6B, it is possible to describe a process having two conditions (CONDITIONS 1 and 2) and a default task (Task 3) that is performed when the two conditions are not satisfied in the present embodiment.

Note that a child task of a conditional node is not necessarily represented with an indent as in FIGS. 4A, 5A, and 6A, but may be represented by changing an icon for a child task, or represented with an additional column (item) to indicate whether it is a child task.

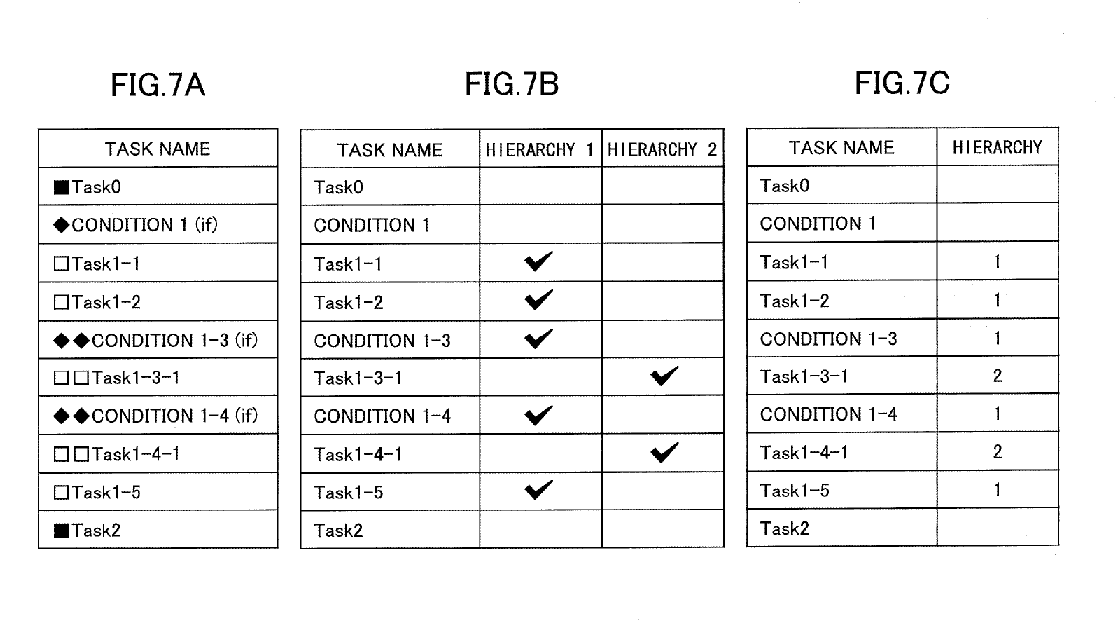

FIGS. 7A-7C are schematic views illustrating an example of task hierarchy setting information. When specifying setting information with the first editor 12 to represent a Gantt chart in the present embodiment, each task can be set with the setting information using methods illustrated in in FIGS. 7A-7C

In the example in FIG. 7A, a conditional formula following another conditional formula (parent-child relationship) is represented by using multiple icons, changing the type of the icon, or adding an icon for a child task (for example, designated with “□”). For example, “♦♦ CONDITION 1-3 (if)” in FIG. 7A designates that it is a task performed after “□ Task 1-2”. In this way, a parent-child relationship between tasks is set with the icons in the example in FIG. 7A.

Alternatively, in the example in FIG. 7B, columns (items) are added for describing levels in a hierarchy in a Gantt chart. Columns of HIERARCHY 1 and HIERARCHY 2 are added in the example in FIG. 7B. For example, the column of HIERARCHY 1 is set with a check mark for a task performed following a conditional formula at the first level of the hierarchy. Also, the column of HIERARCHY 2 is set with a check mark for a task performed following a conditional formula at the second level of the hierarchy, namely, following a conditional formula defined following another conditional formula. In this way, a parent-child relationship between tasks is set with setting check marks at corresponding hierarchy levels in the example in FIG. 7B.

Also, in the example in FIG. 7C, a column of HIERARCHY is added in the Gantt chart, in which a numerical value representing a hierarchical level is set for a corresponding task. In the example in FIG. 7C, child tasks are set with “1”, and grandchild tasks are set with “2”. In this way, a parent-child relationship between tasks is set with setting a numerical value to represent a hierarchical level in the example in FIG. 7C.

To describe a Gantt chart in the present embodiment, the first editor 12 can set the meaning of a task (conditional node) to represent a conditional branch (if) or repeat control (while do, or do while) as an execution attribute. In this case, a conditional node can be set with a conditional formula and the type of the conditional node. For example, as the type of a conditional node, one of “if”, “while do”, and “do while” can be set, which represents an execution order relationship for multiple tasks.

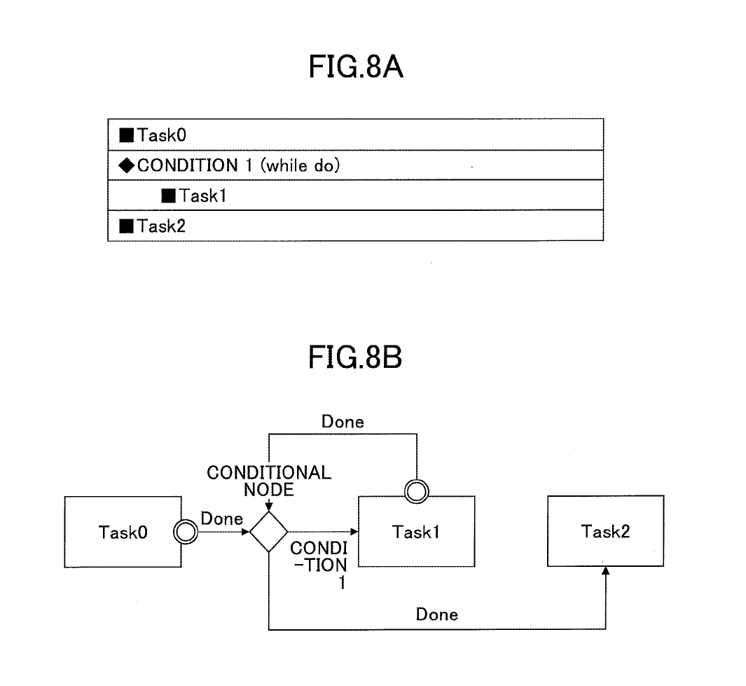

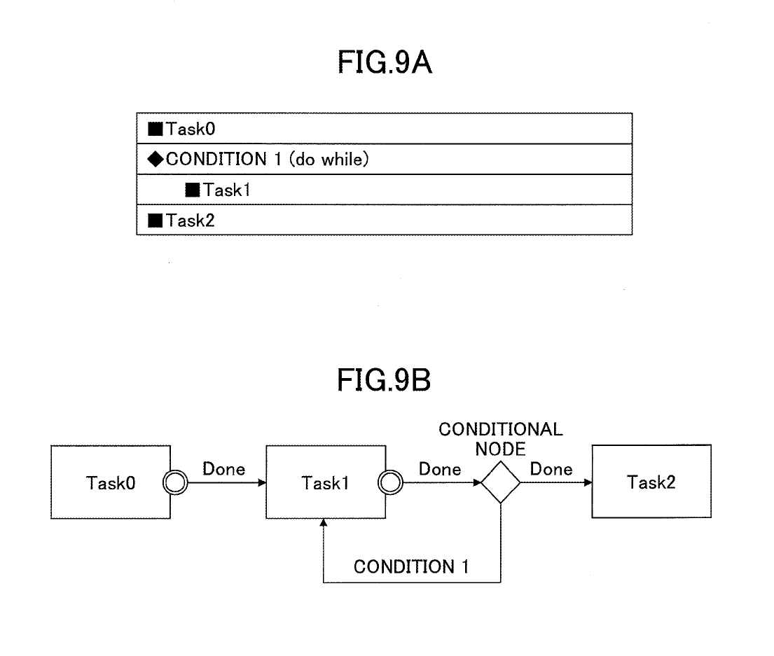

Here, FIGS. 8A-8B are schematic views illustrating a correspondence between a Gantt chart and a process definition flow with respect to “while do”. And, FIGS. 9A-9B are schematic views illustrating a correspondence between a Gantt chart and a process definition flow with respect to “do while”. FIGS. 8A and 9A illustrate examples of Gantt charts, and FIGS. 8B and 9B illustrate examples of process definition flows, respectively.

For example, as illustrated in FIGS. 8A-8B, if the type of a conditional node is “while do”, a child task (Task 1) of the conditional node is repeatedly executed while a conditional formula set to the conditional node is satisfied.

Also, as illustrated in FIGS. 9A-9B, if the type of a conditional node is “do while”, a child task (Task 1) of the conditional node is executed once, and then, the child task (Task 1) is repeatedly executed while a conditional formula set to the conditional node is satisfied.

A child task of a conditional node is not necessarily shown with an indent or the like as illustrated in FIGS. 8A and 9A, but may be shown, for example, with a changed icon to represent a child task, or by adding a column to represent a child task.

As described above, conditional nodes described in a process definition flow can be represented in the Gantt chart in the present embodiment. With bar displays (time lines) and the like, the Gantt chart can be used for schedule and progress management to realize appropriate work management.

<Example of Process Definition>

Next, an example of a process definition described above will be described. In the present embodiment, a process definition file 25 is updated for a Gantt chart or a process definition flow that has been edited (generated or changed).

In a process definition, each node in a process definition flow is managed with the following items: a node name; a person in charge; screen information for operation of work; a duration of work; a list of incoming arrows to the node; and a list of outgoing arrows from the node. Also, each arrow is managed with an arrow name; node information of the connection source; and node information of the connection destination.

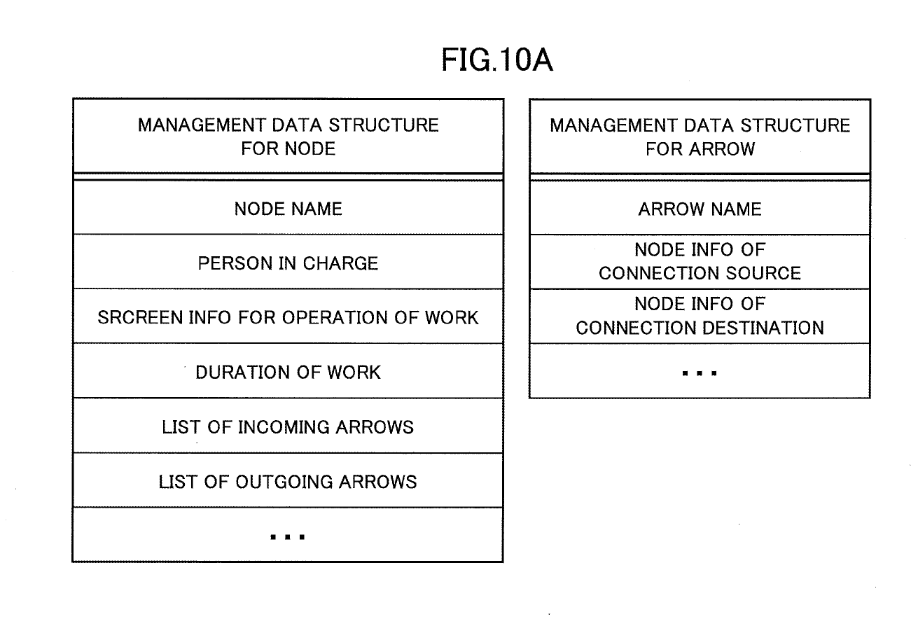

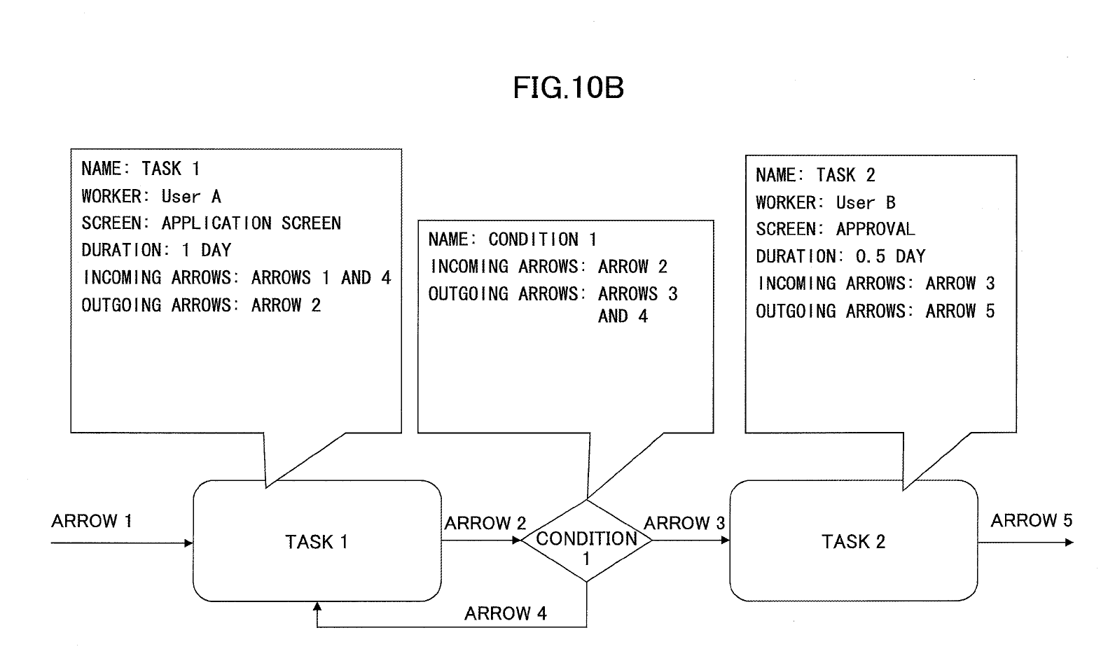

FIGS. 10A-10B are schematic views illustrating an example of a management data structure in a process definition. FIG. 10A illustrates the management data structure of a node, and the management data structure of an arrow (branch) connecting nodes in a process definition flow.

Data items of the management data structure of a node includes, for example, a node name; a person in charge; screen information for operation of work; a duration of work; a list of incoming arrows to the node; and a list of outgoing arrows from the node, but the items are not limited to these. Data items of the management data structure of an arrow includes, for example, an arrow name; node information of the connection source; and node information of the connection destination, but the items are not limited to these.

By defining the management data structures for nodes and arrows as in FIG. 10A, the nodes and arrows can be added with information, for example, as illustrated in FIG. 10B, using the first editor 12 and the second editor 13 in the present embodiment.

For example, in the example in FIG. 10B, TASK 1 is set with “NAME: TASK 1”, “WORKER: User A”, “SCREEN: APPLICATION SCREEN”, “DURATION: 1 DAY”, “INCOMING ARROWS TO TASK 1: ARROWS 1 AND 4”, and “OUTGOING ARROWS FROM TASK 1: ARROW 2” as the process definition. Also, CONDITION 1 is set with “NAME: CONDITION 1”, “INCOMING ARROWS: ARROW 2” (to CONDITION 1), and “OUTGOING ARROWS: ARROWS 3 AND 4” (from CONDITION 1) as the process definition. Also, TASK 2 is set with “NAME: TASK 2”, “WORKER: User B”, “SCREEN: APPROVAL”, “DURATION: 0.5 DAY”, “INCOMING ARROWS: ARROW 3” (to TASK 2), and “OUTGOING ARROWS: ARROW 5” (from TASK 2) as the process definition.

<Example of Conditional Node Determination Process in Gantt Chart Editor 23>

When converting a process definition flow to a Gantt chart, the type of a conditional node in the process definition flow needs to be determined. A conditional node has a 1-to-n relationship between its representation in a Gantt chart and its representations in a process definition flow. Therefore, a conditional node determination process is executed in the Gantt chart editor 23. Specifically, using the various management data for a process definition, the Gantt chart editor 23 attaches predetermined marks to nodes reachable from a conditional node in a process definition flow, and identifies condition nodes of “if”, “while do”, and “do while”.

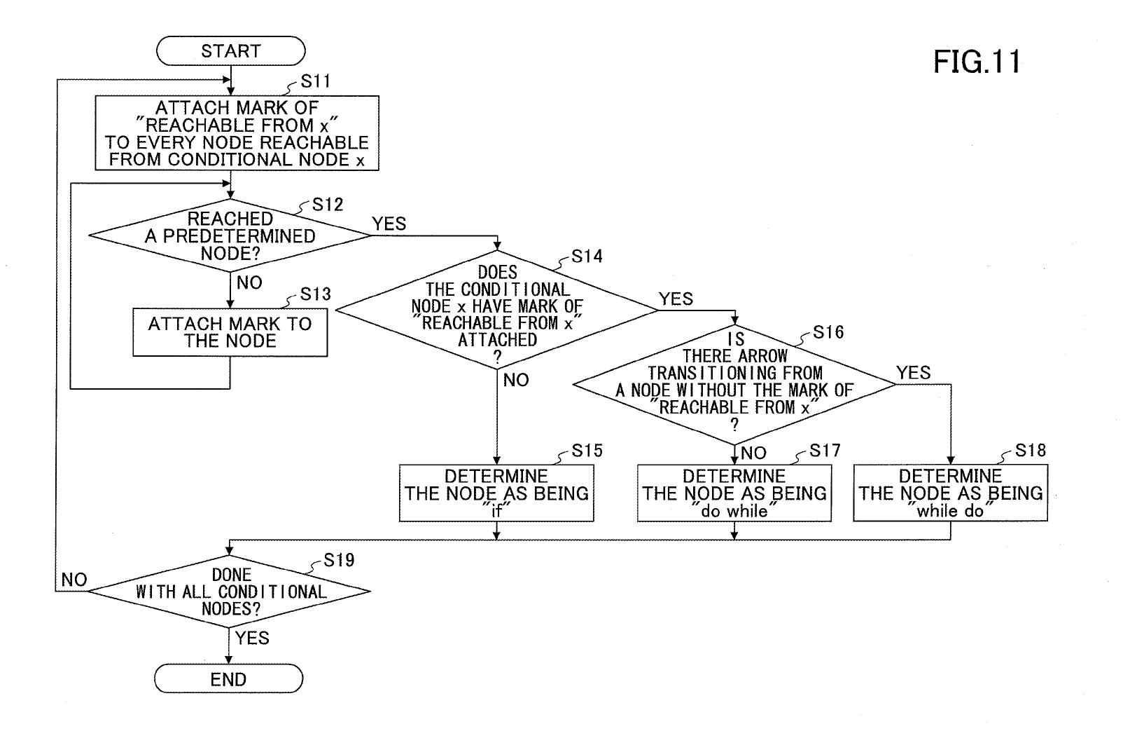

FIG. 11 is a flowchart illustrating an example of the conditional node determination process in the Gantt chart editor 23. Note that the example in FIG. 11 identifies the three condition nodes of “if”, “while do”, and “do while”, but the types and numbers of conditional nodes are not limited to these.

In the example in FIG. 11, the Gantt chart editor 23 attaches a mark “reachable from x” to every node that is reachable from a conditional node x for which the determination is being made (Step S11). Note that Step S11 is recursively applied to branches until reaching predetermined nodes including an end node (Exit), a node having the mark of “reachable from x” attached, the conditional node x itself, and a conditional node having the determination applied.

Therefore, the Gantt chart editor 23 determines whether a reached node is one of the predetermined nodes (Step S12), and if it is not (NO at Step S12), attaches the mark “reachable from x” to the reached node (Step S13), and goes back to Step S12. If reaching one of the predetermined nodes (YES at Step S12), the Gantt chart editor 23 determines whether the conditional node x has the mark “reachable from x” (Step S14), and if the conditional node x does not have the mark attached (NO at Step S14), determines that the conditional node x is an “if” (Step S15).

If the conditional node x has the mark “reachable from x” attached (YES at Step S14), the Gantt chart editor 23 determines whether there is an arrow transitioned from a node not having the mark “reachable from x” attached (Step S16). If there are no arrows transitioned from a node not having the mark “reachable from x” attached (NO at Step S16), the Gantt chart editor 23 determines that the conditional node x is a “do while” (Step S17). If there is an arrow transitioned from a node not having the mark “reachable from x” attached (YES at Step S16), the Gantt chart editor 23 determines that the conditional node x is a “while do” (Step S18).

Next, after having Step S15, S17, or S18 executed, the Gantt chart editor 23 determines whether it has done all conditional nodes (Step S19), and if not having done all conditional nodes (NO at Step S19), goes back to Step S11. If done with all conditional nodes (YES at Step S19), the process ends.

<Concrete Example of Conditional Node Determination>

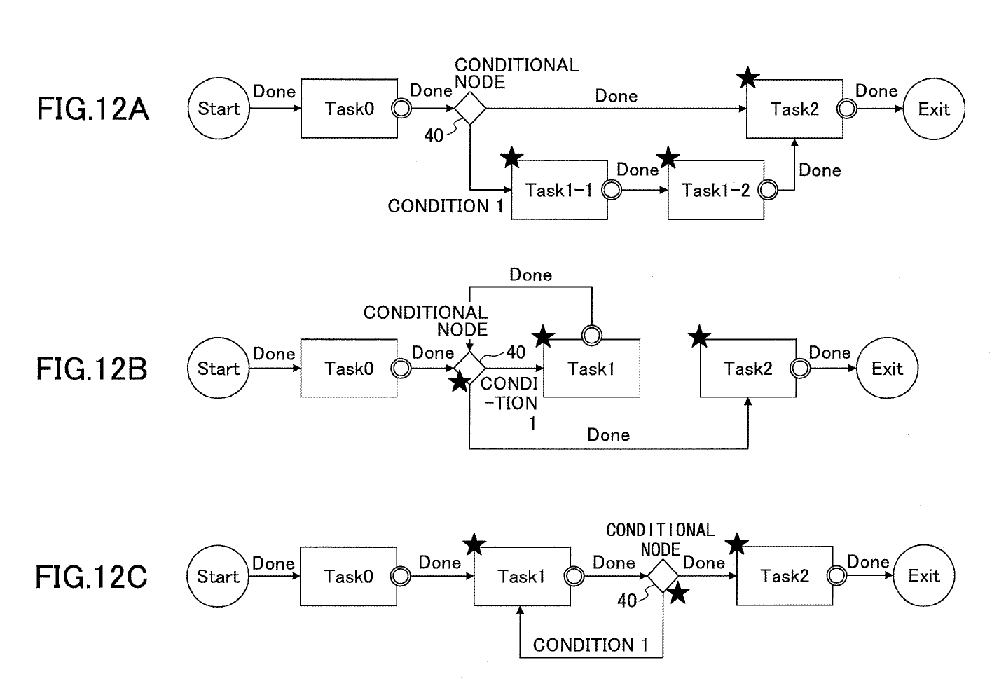

Next, based on the process in FIG. 11, a concrete example of conditional node determination will be described using the drawings. FIGS. 12A-12C are schematic views illustrating an example where marks are attached to tasks reachable from a conditional node. Note that FIG. 12A illustrates an example where a conditional node 40 of “if” is checked, FIG. 12B illustrates an example where a conditional node 40 of “while do” is checked, and FIG. 12C illustrates an example where a conditional node of “do while” is checked. For example, the conditional node 40 in FIGS. 12A-12C represents a conditional node x in FIG. 11, and “★” represents the mark “reachable from x”. Note that the mark is not limited to “★”.

As illustrated in FIG. 12A, the Gantt chart editor 23 determines the conditional node x as being “if” if the conditional node 40 does not have the mark (★) of “reachable from x (the conditional node 40)” attached as described above. If the conditional node 40 has the mark attached, the Gantt chart editor determines the conditional node x as a part of a loop (repeat control).

If determining the conditional node x as a part of a loop, and if there is an arrow transitioned from a node without the mark (★) to the conditional node 40 as illustrated in FIG. 12B, the Gantt chart editor 23 determines that the conditional node 40 is “while do”. If determining the conditional node x as a part of a loop, and if there are no arrows transitioned from a node without the mark (★) to the conditional node 40 as illustrated in FIG. 12C, the Gantt chart editor 23 determines that the conditional node 40 is “do while”.

Note that when determining a conditional node as being, for example, “if”, the Gantt chart editor 23 traces all arrows from the conditional node until they join again at a succeeding node, and determines conditional nodes (grandchild conditional nodes and the like) detected during the trace, as conditional nodes following the conditional node.

Also, when determining a conditional node as being, for example, “while do” or “do while”, the Gantt chart editor 23 traces the loop from the conditional node, and determines conditional nodes (grandchild conditional nodes and the like) detected during the trace, as conditional nodes following the conditional node. The Gantt chart editor 23 applies the process to all conditional nodes.

Next, examples will be described for a case where a nesting of conditional nodes of “if” exists, and a case where “while do”, “do while” and “if” coexist.

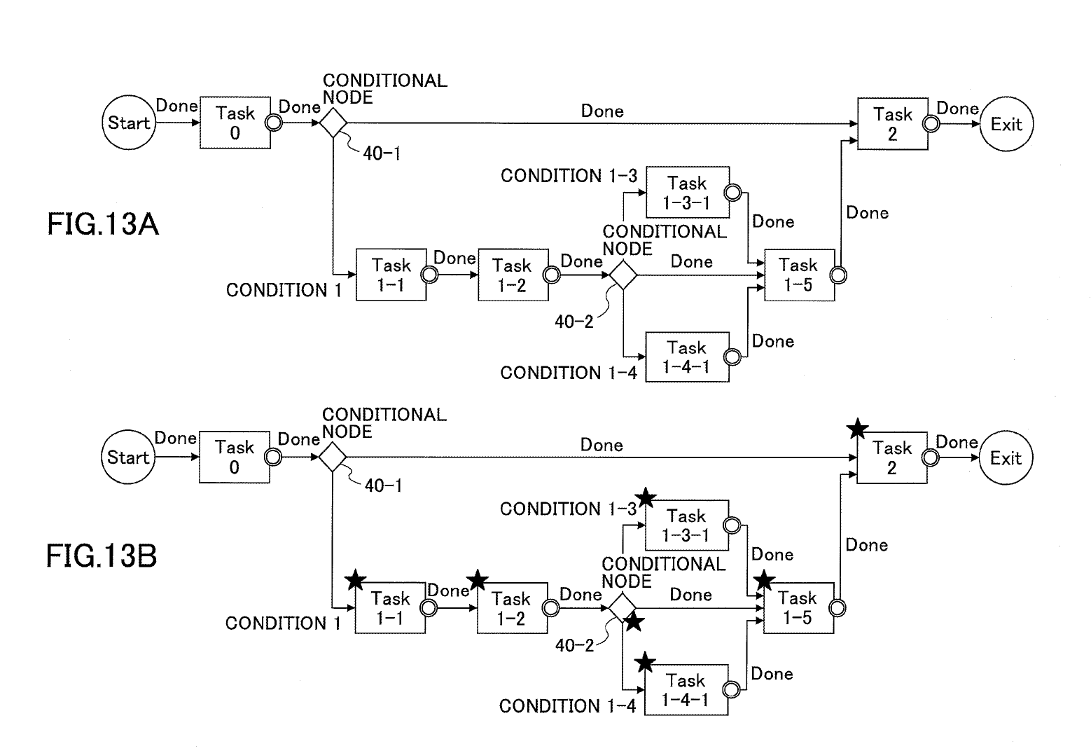

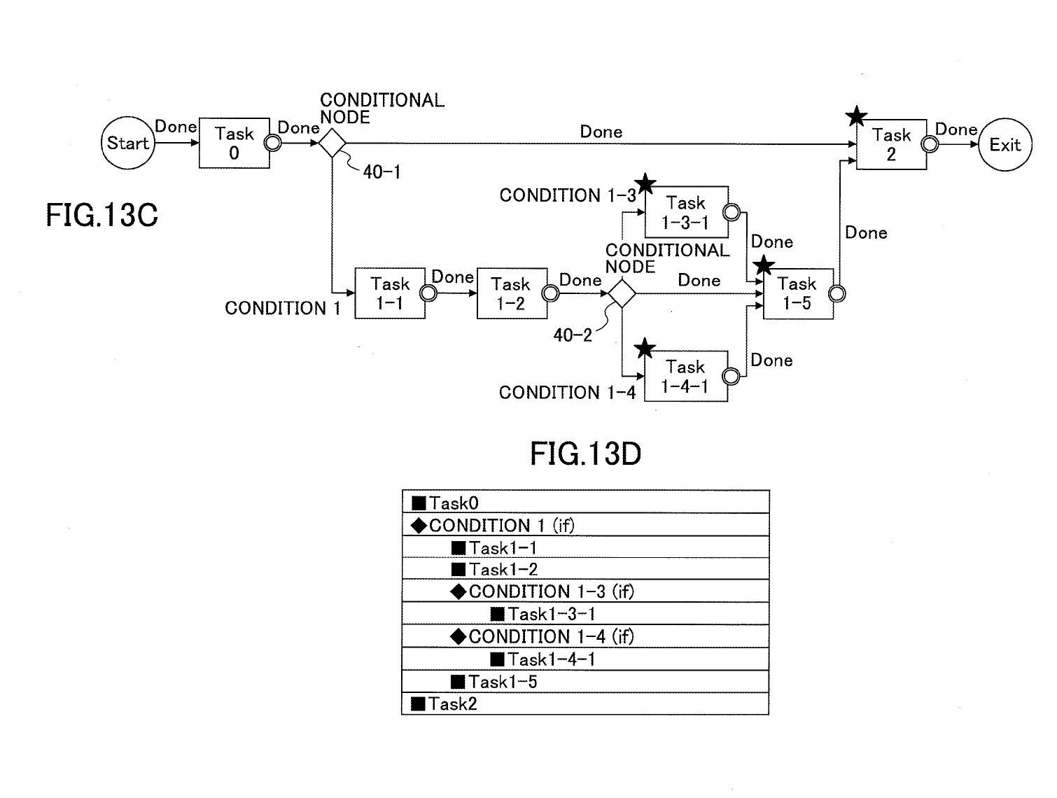

FIGS. 13A-13D, 14A-14D, and 15A-15D are first to third schematic views illustrating determination examples of conditional nodes in cases where multiple conditional nodes coexist, respectively.

In the example in FIGS. 13A-13C, for a process definition flow illustrated in FIG. 13A, the Gantt chart editor 23 attaches marks (★) to nodes (tasks, etc.) reachable from a conditional node 40-1 as illustrated in FIG. 13B by the conditional node determination process.

The Gantt chart editor 23 determines a conditional node 40-1 as an “if” in FIG. 13B because the conditional node 40-1 does not have the mark.

When making the determination for a conditional node 40-2, the Gantt chart editor 23 attaches the marks to nodes reachable from a conditional node 40-2 as illustrated in FIG. 13C by the conditional node determination process. In this case, the Gantt chart editor 23 attaches the marks to nodes reachable from the conditional node 40-2, and does not need to attach the mark to the conditional node 40-1.

The Gantt chart editor 23 determines the conditional node 40-2 as an “if” in FIG. 13C because the conditional node 40-1 does not have the mark. Therefore, the process definition flow illustrated in FIG. 13A is converted to a corresponding Gantt chart as illustrated in FIG. 13D, in which a nesting of “if” is included.

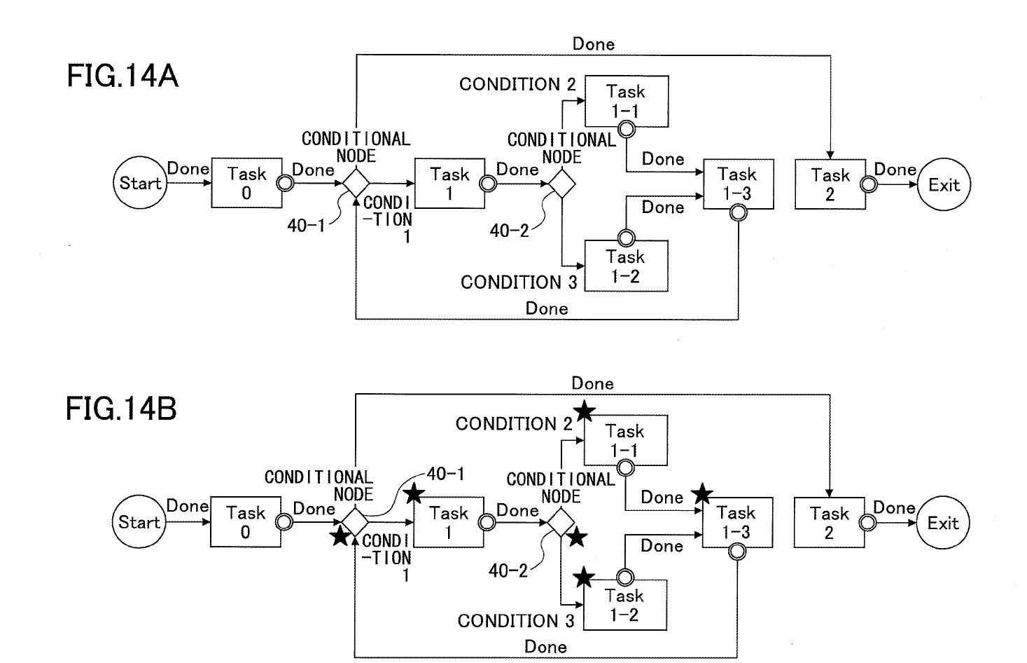

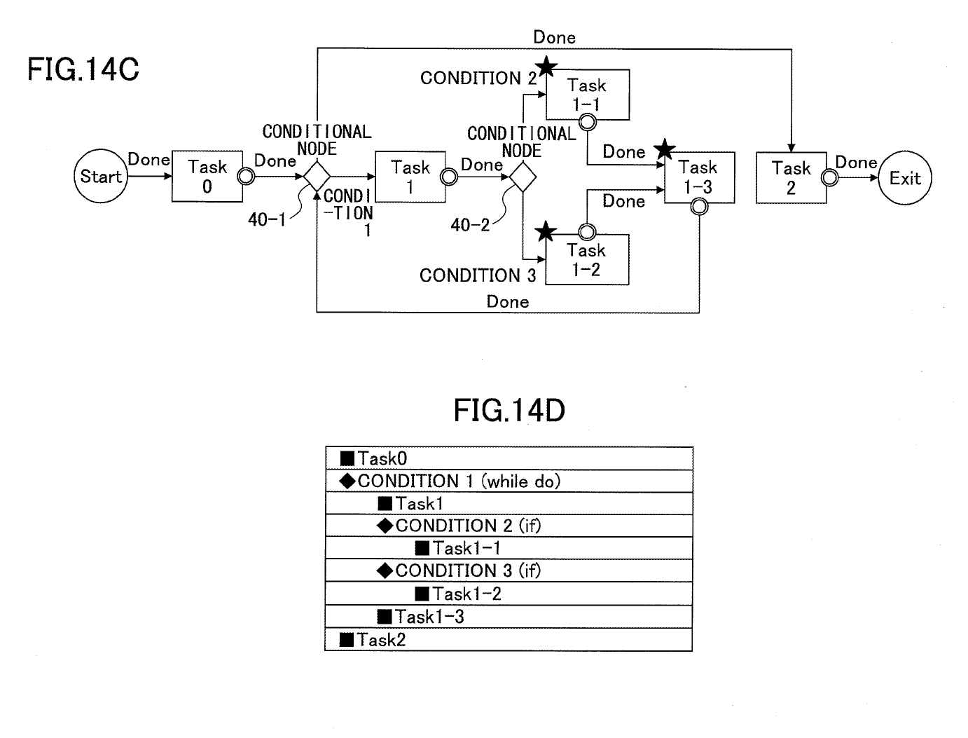

In the example in FIGS. 14A-14C, for a process definition flow illustrated in FIG. 14A, the Gantt chart editor 23 attaches marks (★) to nodes reachable from a conditional node 40-1 as illustrated in FIG. 14B by the conditional node determination process.

The Gantt chart editor 23 determines a conditional node 40-1 as a “while do” in FIG. 14B because the conditional node 40-1 has the mark, and there is an arrow transitioned from a node without the mark (Task 0) to the conditional node 40-1.

When making the determination for a conditional node 40-2, the Gantt chart editor 23 attaches the marks to nodes reachable from the conditional node 40-2 as illustrated in FIG. 14C by the conditional node determination process.

The Gantt chart editor 23 determines a conditional node 40-2 as an “if” in FIG. 14C because the conditional node 40-2 does not have the mark. Therefore, the process definition flow illustrated in FIG. 14A is converted to a corresponding Gantt chart as illustrated in FIG. 14D. In the present embodiment, a process definition flow where an “if” exists following a “while do” can be represented using the Gantt chart as illustrated in FIGS. 14A-14D.

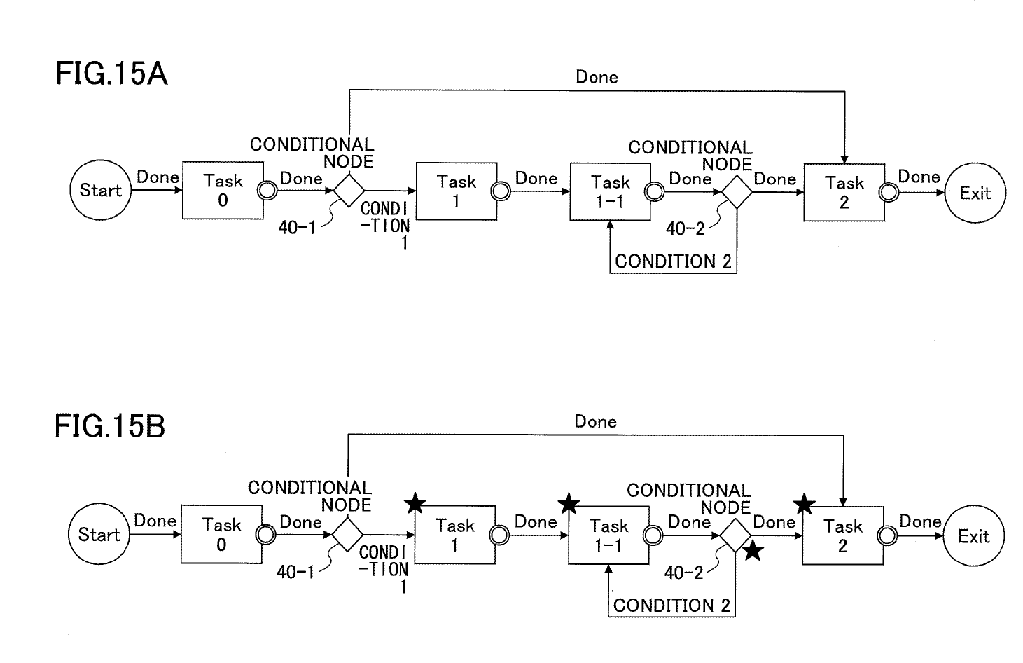

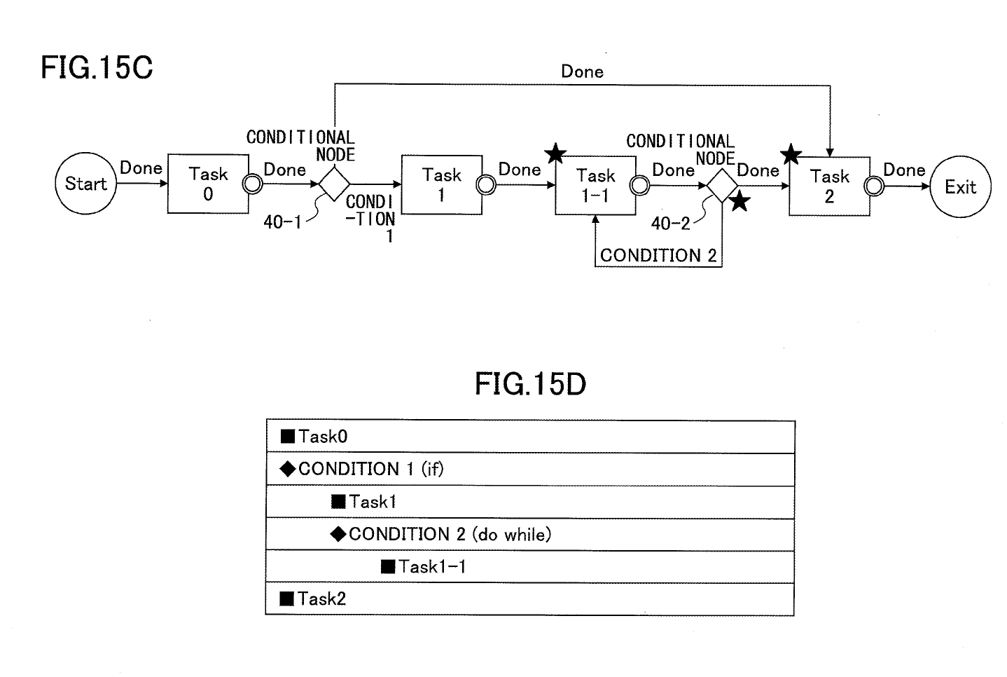

In the example in FIGS. 15A-15C, for a process definition flow illustrated in FIG. 15A, the Gantt chart editor 23 attaches marks (★) to nodes reachable from a conditional node 40-1 as illustrated in FIG. 15B by the conditional node determination process.

The Gantt chart editor 23 determines a conditional node 40-1 as an “if” in FIG. 15B because the conditional node 40-1 does not have the mark.

When making the determination for a conditional node 40-2, the Gantt chart editor 23 attaches the marks to nodes reachable from the conditional node 40-2 as illustrated in FIG. 15C by the conditional node determination process.

The Gantt chart editor 23 determines a conditional node 40-2 as a “while do” in FIG. 15C because the conditional node 40-2 has the mark, and there are no arrows transitioned from nodes without the mark to the conditional node 40-2. Therefore, the process definition flow illustrated in FIG. 15A is converted to a corresponding Gantt chart as illustrated in FIG. 15D. In the present embodiment, a process definition flow where a “while do” exists following an “if” can be represented using the Gantt chart as illustrated in FIGS. 15A-15D.

Note that although the examples in FIGS. 13A-15D are the cases where two conditional nodes coexist, it is not limited to these, and cases where more than two conditional nodes coexist can be processed by the same method. Also, screens having FIGS. 13A-15D or determination results may be generated by the screen generation unit 15 and displayed on the display unit 16 to be confirmed by a user.

In the present embodiment, if a task included in a project to be processed is a conditional node, an execution attribute can be set that specifies an execution order relationship with the other tasks by the conditional node determination. Therefore, a process definition flow can be converted to a Gantt chart in which an execution order relationship is represented according to the present embodiment.

### Gantt Chart Example

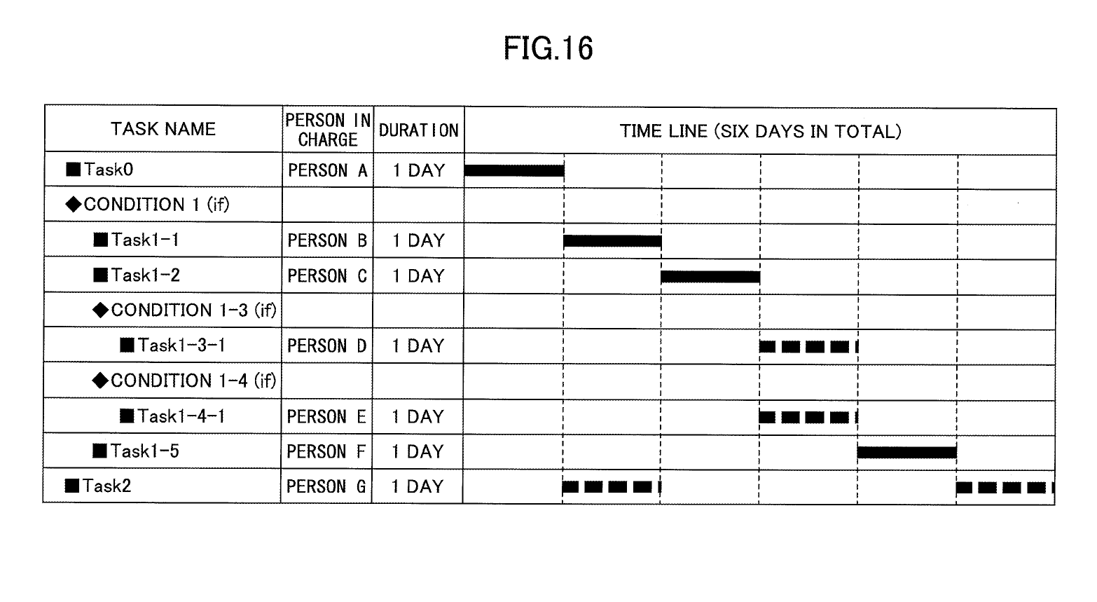

FIG. 16 is a schematic view illustrating an example of a Gantt chart. The Gantt chart illustrated in FIG. 16 has time lines (bar displays) that correspond to contents (conditional branch, repeat control, etc.) of execution attributes set to corresponding tasks (nodes).

In the present embodiment, if a time line for a task in which execution based on the determination result of a conditional node is not determined, the time line may be displayed with a dotted line or the like to distinguish it from the other time lines as illustrated FIG. 16. This makes it possible for a user to easily see the task in which execution has not been determined.

Note that the Gantt chart is displayed with fields of “TASK NAME”, “PERSON IN CHARGE”, “DURATION”, and “TIME LINE” in the example in FIG. 16, but it is not limited to these. Content displayed on a Gantt chart can be obtained from, for example, information in the management data structure. Also, although a “TASK NAME” in FIG. 16 is displayed with indents (steps) in accordance with the hierarchy of parent-child relationships, and with predetermined icons for representing execution order relationships of multiple tasks, it is not limited to these. For example, the color, shape, style and/or the like of characters of a task name may be changed to clarify execution attributes.

In the present embodiment, as illustrated in FIG. 16, an execution order relationship of multiple tasks can be represented explicitly on the Gantt chart, conditional branching and repeat controls that cannot be defined in a conventional Gantt chart can be determined, and a process including such control can be described.

Also, in the present embodiment, as illustrated in FIGS. 13A-15D, a process definition flow can be converted to a Gantt chart; also, a Gantt chart in the present embodiment can be converted to a process definition flow.

As described above, according to the present embodiment, appropriate work management can be realized. In the present embodiment, using elements directly represented in a Gantt chart, execution contents that correspond to execution steps can be described. In the present embodiment, for example, an execution order relationship of multiple tasks included in a work process can be clearly specified. Therefore, the work process (workflow) can be described that includes conditional branching and repeat controls that cannot be defined in a conventional Gantt chart.

For example, conventionally, a person in charge at a site or a person in charge of consulting, who may not be familiar with a system, are forced to edit a process definition using a process definition flow to generate a work process or the like. However, by using the present embodiment, the person in charge at a site or the person in charge of consulting can use a Gantt chart, which has been widely used, to generate and change the workflow more simply.

Also, in the present embodiment, process description in a Gantt chart can be expanded to improve representation capability. Also, in the present embodiment, by adding new meanings to a conditional node in a Gantt chart, and by elaborating on the analysis of a process definition flow, bidirectional conversion between a Gantt chart and a process definition flow is implemented.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that various changes, substitutions, and alterations could be made hereto without departing from the spirit and scope of the invention.

What is claimed is:

1. A work management method executed by an information processing apparatus, the method comprising:
setting an execution attribute for each of a plurality of tasks included in a work process, the execution attribute specifying an execution order relationship with respect to the other tasks in the plurality of tasks; and
generating a Gantt chart using the plurality of tasks having the execution attributes set,
wherein a child task of tasks having a parent-child relationship among the plurality of tasks included in the generated Gantt chart has execution content corresponding to the execution attribute set for a parent task of the tasks having the parent-child relationship.

2. The work management method as claimed in claim 1, wherein the execution attribute and the parent-child relationship are set for each of the plurality of tasks constituting the Gantt chart, using at least one of a label, a description position, a column description, and a bar display of the task.

3. The work management method as claimed in claim 1, wherein the execution content is a conditional branch or repeat control for the task.

4. The work management method as claimed in claim 1, wherein a conditional node included in a process definition flow set beforehand is determined, then based on a result of the determination, the execution attribute is set for the task included in the work process for converting the process definition flow to the Gantt chart.

5. The work management method as claimed in claim 4, wherein one or more nodes reachable from the conditional node included in the process definition flow are attached with predetermined marks, respectively, to determine the conditional node based on the nodes having the marks attached.

6. The work management method as claimed in claim 1, wherein the Gantt chart is generated having an icon displayed for each of the plurality of tasks, the icon corresponding to the execution attribute and the parent-child relationship.

7. A non-transitory computer-readable recording medium having a program stored therein for causing a computer to execute a work management process, the work management process comprising:
setting an execution attribute for each of a plurality of tasks included in a work process, the execution attribute specifying an execution order relationship with respect to the other tasks in the plurality of tasks; and
generating a Gantt chart using the plurality of tasks having the execution attributes set,
wherein a child task of tasks having a parent-child relationship among the plurality of tasks included in the generated Gantt chart has execution content corresponding to the execution attribute set for a parent task of the tasks having the parent-child relationship.

8. An information processing apparatus, comprising:
a Gantt chart editor configured to set an execution attribute for each of a plurality of tasks included in a work process, the execution attribute specifying an execution order relationship with respect to the other tasks in the plurality of tasks, and to generate a Gantt chart using the plurality of tasks having the execution attributes set,
wherein a child task of tasks having a parent-child relationship among the plurality of tasks included in the generated Gantt chart has execution content corresponding to the execution attribute set for a parent task of the tasks having the parent-child relationship.
